(19) United States
(12) Patent Application Publication
(10) Pub. No.: US 2014/0067191 A1
(43) Pub. Date: Mar. 6, 2014

(54) VEHICLE CONDITION INFORMING SYSTEM

(71) Applicant: SUZUKI MOTOR CORPORATION, Shizuoka (JP)

(72) Inventor: Atsushi HAMAI, Shizuoka (JP)

(73) Assignee: SUZUKI MOTOR CORPORATION, Shizuoka (JP)

(21) Appl. No.: 14/011,949

(22) Filed: Aug. 28, 2013

(30) Foreign Application Priority Data
Sep. 5, 2012 (JP) 2012-194977

(51) Int. Cl. G01M 17/007

(52) U.S. Cl. CPC G01M 17/007
USPC 701/29.4

(57) ABSTRACT

A vehicle system 1 includes an input interface set 52 for reservation of a charge service for a batter set 15 and reservation of an air-conditioning service, an indicator set 51 disposed inside or outside a vehicle, and a controller 54 for controlling the indicator set 51 to put in a first lighting state representing combination of a condition involving a start time set up for the charge or air-conditioning service and a condition of an external power supply 200 ready to supply electric power to the battery set 15, and a second lighting state representing the charge or air-conditioning service being executed.

### CROSS-REFERENCE TO RELATED APPLICATION

This application is based upon and claims the benefit of priority from Japanese Patent Application No. 2012-194977, filed Sep. 5, 2012, the entire contents of which are incorporated herein by reference.

### BACKGROUND OF INVENTION

1. Technical Field

This invention relates to techniques of giving information on conditions of a vehicle adapted to charge a vehicle-mounted battery set with electric power supplied from an external power supply, and receive reservations for a charge service and an air-conditioning service.

2. Background Art

There are vehicles, such as plug-in hybrid automobiles (PHEVs) and electric automobiles (EVs), adapted to charge a set of vehicle-mounted batteries with electric power supplied from an external power supply. Charging a vehicle-mounted battery set at such a vehicle is enabled by labor of the user working for the charge. That charge work includes connecting a charge plug to a charge port at a vehicle body end, to supply electric power from an external power source. In the charge work, the user has to check situations associated with the charge. For instance, the user is required to give checks to situations of charge, such as for a charge service to be started, or for a started charge service interrupted by a vehicular trouble in the way. However, such checks are uneasy for unfamiliar users.

For such reasons, there are conventional techniques of indicating situations of charge on a meter at an interior of a vehicle, giving as information to the user. However, there are involved tasks for the user to check indications on the meter, with inconveniency felt by the user.

Among vehicles adapted to drive with electric power of a vehicle-mounted battery set charged from an external power supply, there are those which have additional functions including a function of receiving a reserved charge service (i.e., a charge service reserving function) and a function of receiving a reserved air-conditioning service (i.e., an air-conditioning service reserving function). The reserved charge service receiving function includes functions for tasks involving those to permit the user to have a charge service automatically started at an arbitrary clock time, or the user to have a charge service ended at an arbitrary clock time. The reserved air-conditioning service receiving function includes functions for tasks involving those to permit the user to have an air conditioner automatically operated at an arbitrary clock time. Even at vehicles provided with such functions including a reserved charge service receiving function and a reserved air-conditioning service receiving function, there are needs for implements to inform a user outside a vehicle, of vehicular situations such as situations of reservation. There might be an arrangement for indicating such vehicular situations on a meter in an interior of a vehicle, to give as information to the user, subject to inconveniency felt by the user, like the techniques described.

As techniques of informing vehicular situations, there are techniques disclosed in JP 4831037 B and JP 4930289 B.

In JP 4831037 B there is disclosed a technique addressed to an electric automobile adapted to charge a vehicle-mounted battery set with electric power supplied from an external power supply. This technique employs lighting conditions of an indicator provided at a vehicle, to thereby inform the user of situations including those of reservations for a charge service to the battery set and a preliminary air-conditioning service.

In JP 4930289 B there is disclosed a technique addressed to an electromotive vehicle that also is adapted for use of an external power supply to make a charge. This technique can accommodate a reservation to start charging a battery device. This technique employs a lighting device provided outside a vehicle to render different manners of lighting for an interval between a time point for a charge service starting clock time to be set and a time point for an actual charge service to be started, for an interval over the charge service, and after completion of the charge service. This technique permits the user to understand with ease a state of charge at the battery device based on a lighting state of the lighting device.

### SUMMARY OF INVENTION

The technique disclosed in JP 4831037 B serves while a reservation of a charge service to a battery set or a preliminary air-conditioning service as set up is waiting for execution, to make an indicator blink on and off, thereby informing a user of the reservation as set up.

The technique disclosed in JP 4930289 B serves during the interval between the time point for a charge service starting clock time to be set and the time point for an actual charge service to be started, to make the lighting device lit intermittently, thereby informing a user of a reservation as set up. However, those techniques permit a reservation to be set up as described, even in a situation in which the vehicle is unable to receive electric power from an external power supply (for instance, in such a situation as involving a charge plug disconnected from a charge port).

As a result, the techniques disclosed in JP 4831037 B or JP 4930289 B may suffer from a failure to render a charge service or preliminary air-conditioning service using electric power supplied from an external power supply, even after a start time for execution of a reservation as set up, due to a situation involving the vehicle unable to receive electric power from the external power supply, while the reservation has been set up, as an issue.

This invention has been devised in view of the foregoing. It is an object of this invention to prevent situations involving a failure to render a charge service or preliminary air-conditioning service using electric power supplied from an external power supply, at or after a start time for execution of a reservation as set up.

To achieve the object described, according to an aspect of this invention, there is provided a vehicle condition informing system adapted to inform a vehicle condition set of a vehicle. The vehicle includes a battery set mounted on the vehicle and adapted to charge from an external power supply, and an air conditioner operable for air conditioning services to be rendered when the external power supply is put in a state affording to supply electric power to the battery set. The vehicle condition informing system includes a charge service reservation setter, an air-conditioning service reservation setter, a charge service executer, an air-conditioning service executer, a lighting element set, and a controller. The charge service reservation setter is configured for a setup to be made of a reservation for execution of a charge service to the battery set. The air-conditioning service reservation setter is configured for a setup to be made of a reservation for execution of an air-conditioning service. The charge service executer is configured to start charging the battery set at a charge service starting clock time set up by the charge service reservation setter. The air-conditioning service executer is configured to execute the air-conditioning service at an air-conditioning service starting clock time set up by the air-conditioning service reservation setter. The lighting element set includes a first lighting element subset thereof disposed at an interior of or at an outside of the vehicle. The controller is configured to control an action set of the lighting element set. The controller is adapted to put the lighting element set in a first lighting state representing a first subset of the vehicle condition set, and in a second lighting state representing a second subset of the vehicle condition set, the second lighting state being different from the first lighting state. The first subset of the vehicle condition set includes a combination of a condition of the charge service reservation setter having set the charge service starting clock time or a condition of the air-conditioning service reservation setter having set the air-conditioning service starting clock time, and a condition of the external power supply put in the state affording to supply electric power to the battery set. The second subset of the vehicle condition set includes the charge service to the battery set or the air-conditioning service being executed.

### BRIEF DESCRIPTION OF THE DRAWINGS

FIG. 1 is a diagram showing an example of configuration of a vehicle system according to an embodiment described herein.

FIG. 2 is a diagram showing an example of arrangement of an indicator element at a vehicle.

FIG. 3 is a diagram showing an example of arrangement of another indicator element at the vehicle.

FIG. 4 is a flowchart showing a series of illustrative tasks to be done by a user (e.g. by an occupant) in operations including those for a charge service reservation to be set up inclusive of setting a charge start time, and/or those for a preliminary air-conditioning service reservation to be set up inclusive of setting a preliminary air-conditioning start time, followed by a connection of a charge plug to a charge port.

FIG. 5 is a flowchart showing an example of processing to be implemented at a meter controller, when a clock gets to the charge start time.

FIG. 6 is a flowchart showing an example of processing to be implemented at a vehicle controller, when the clock gets to the charge start time.

FIG. 7 is a block diagram showing an example of configuration of the vehicle controller.

FIG. 8 is a flowchart showing an example of processing to be implemented at the meter controller, when the clock gets to the preliminary air-conditioning start time.

FIG. 9 is a flowchart showing an example of processing to be implemented at the vehicle controller, when the clock gets to the preliminary air-conditioning start time.

FIG. 10 is a flowchart showing an example of processing to be implemented at an indicator controller included in a meter controller for a lighting control of an indicator set.

FIG. 11 is a block diagram showing an example of configuration of the meter controller.

FIG. 12 is a diagram showing illustrative communications of various pieces of information in the vehicle system.

FIG. 13 is a diagram showing illustrative patterns of indicator actions under control by the indicator controller.

FIG. 14 is a flowchart showing an example of processing to be implemented at an indicator controller in a mode of lighting control for a charge indicator according to a second embodiment.

FIG. 15 is a flowchart showing an example of processing to be implemented at the indicator controller in a mode of lighting control for an air-conditioning indicator according to the second embodiment.

### DESCRIPTION OF EMBODIMENTS

There will be descried embodiments of this invention with reference to the drawings.

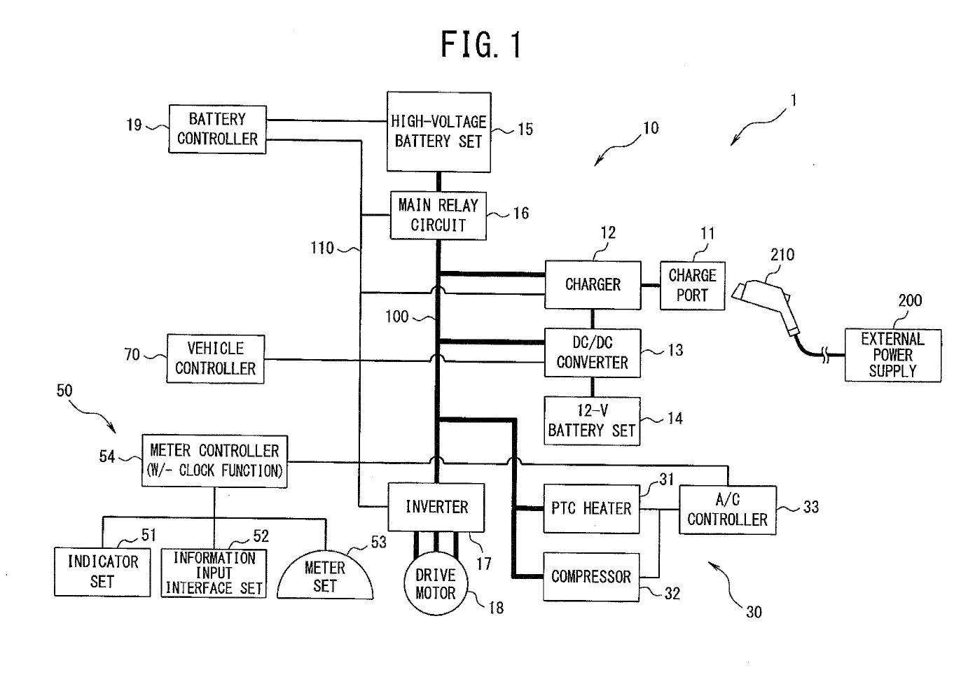

### Embodiments Concerning Any One of FIG. 1 Through FIG. 13

Description is now made of embodiments with reference to FIG. 1 through FIG. 13.

For embodiments to be described herein there is taken a vehicle including a vehicular air-conditioning system and a vehicular drive system that has a drive motor for traction. The vehicle may be a plug-in hybrid vehicle (PHEV), an electric vehicle (EV), or the like being adapted to charge a set of vehicle-mounted batteries with electric power supplied from an external power supply.

### Configuration

FIG. 1 shows an example of configuration of a vehicle system 1 according to an embodiment of this invention. As shown in FIG. 1, the vehicle system 1 includes a vehicular drive system 10, a vehicular air-conditioning system 30, a vehicular meter & indicator control system 50, and a vehicle controller 70. The vehicle system 1 has a high-voltage system including a high-voltage line 100 for high-voltage power distribution and collection, and a communication system including a CAN (controller area network) communication line 110 adapted for communications among equipment and appliances constituting the foregoing systems.

The drive system 10 includes a charge port 11, a charger 12, a dc/dc converter 13, a 12-V battery set (i.e., low-voltage battery set) 14, a high-voltage battery set 15, a main relay circuit 16, an inverter 17, a drive motor 18, and a battery controller (sometimes referred to as a motor controller) 19.

The high-voltage line 100 is connected to the charger 12, the dc to dc converter 13, the high-voltage battery set 15, the main relay circuit 16, and the inverter 17. The CAN communication line 110 is connected to the charger 12, the dc to dc converter 13, the high-voltage battery set 15, the main relay circuit 16, and the inverter 17.

The charge port 11 is made up for a detachable reception of a charge plug 210 that is electrically connected to an external power supply (e.g., a 100-V or 200-V external power supply) 200. With the charge plug 210 inserted, the charge port 11 connected thereto can serve to supply the charger 12 with electric power supplied through the charge plug 210.

Electric power supplied to the charger 12 is processed as necessary for adaptation including a rectification and a voltage conversion, to supply through the high-voltage line 100 to the high-voltage battery set 15, with the main relay circuit 16 connected in between. The high-voltage battery set 15 is thus charged. It is noted that the charger 12 and the main relay circuit 16 are controlled by the battery controller 19.

The high-voltage battery set 15 is adapted to supply electric power to the 12-V battery set 14, as well as to loads in a 12-V system, via the dc to dc converter 13, where electric power supplied through the high-voltage line 100 is converted to a 12 V. The 12-V battery set 14 is a set of batteries adapted for electric power supply to auxiliary equipment in the vehicle.

The high-voltage battery set 15 is a set of batteries (e.g., in the form of a battery pack) adapted for electric power supply to the drive motor 18. The high-voltage battery set 15 is put under control of the battery controller 19. The high-voltage battery set 15 is connected via the main relay circuit 16 to the inverter 17, which is adapted for control of the drive motor 18 to be driven.

The main relay circuit 16 is operable to make and break conduction for power supply from the high-voltage buttery set 15 to other systems having their voltages. For instance, the inverter 17 has electric power supplied from the high-voltage buttery set 15, which is turned on and off by the main relay circuit 16.

The inverter 17 is adapted to convert high-voltage direct-current power supplied thereto from the high-voltage buttery set 15 through the high-voltage line 100, into three-phase alternate-current power with desirable voltages, which is supplied to the drive motor 18, thereby driving the drive motor 18. The inverter 17 is controlled by the battery controller 19.

The battery controller 19 is operable on bases involving detection values at various sensors including an SOC (state of charge) sensor, to control the charger 12, the dc to dc converter 13, the high-voltage battery set 15, the main relay circuit 16, and the like. For instance, the battery controller 19 may include a microcomputer and peripheries thereof. For instance, the battery controller 19 may be composed of an ECU (electronic control unit) including a CPU, a ROM, a RAM, etc.

The air-conditioning system 30 includes a PTC (positive temperature coefficient) heater 31, a compressor 32, and an A/C (air conditioner) controller 33. The high-voltage line 100 is connected to the PTC heater 31, and the compressor 32. The CAN communication line 110 is connected to the PTC heater 31, the compressor 32, and the A/C controller 33.

The PTC heater 31 is an electric heater employing a positive temperature-coefficient resistor that produces heat when energized by current conduction. The PTC heater 31 is operable with electric power supplied as drive power from the high-voltage battery set 15 through the high-voltage line 100. The PTC heater 31 includes a heater core with a built-in PTC resistor, which serves to warm air in the vehicle interior circulating across the heater core.

The compressor 32 is operable with electric power supplied from the high-voltage battery set 15 through the high-voltage line 100, for circulation of a coolant in a closed coolant line. The coolant line includes an evaporator core. The evaporator core makes an exchange of heat between streams of the coolant as liquefied by compression at the compressor 32 and streams of air passing across the evaporator core. The evaporator core serves to cool and dehumidify air in the vehicle interior circulating across the evaporator core.

The A/C controller 33 is operable on bases including operated conditions of A/C switches at an operation panel and detected values at various sensors, to control pieces of air conditioning equipment including the PTC heater 31 and the compressor 32 to be driven. For instance, the A/C controller 33 may include a microcomputer and peripheries thereof. For instance, the A/C controller 33 may be composed of an ECU including a CPU, a ROM, a RAM, etc.

The meter & indicator control system 50 includes an indicator set 51, an information input interface set 52, a meter set 53, and a meter controller 54. The CAN communication line 110 is connected to the indicator set 51, the information input interface set 52, the meter set 53, and the meter controller 54.

The indicator set 51 is adapted for changes of a subset of a set of lighting conditions to inform a subset of a set of vehicle conditions. The indicator set 51 may have a subset thereof composed of a monochrome LED set for instance. In embodiments concerning any one of FIG. 1 through FIG. 13, the indicator set 51 has changed lighting conditions to inform conditions of a charge service, a preliminary air-conditioning service, and the like.

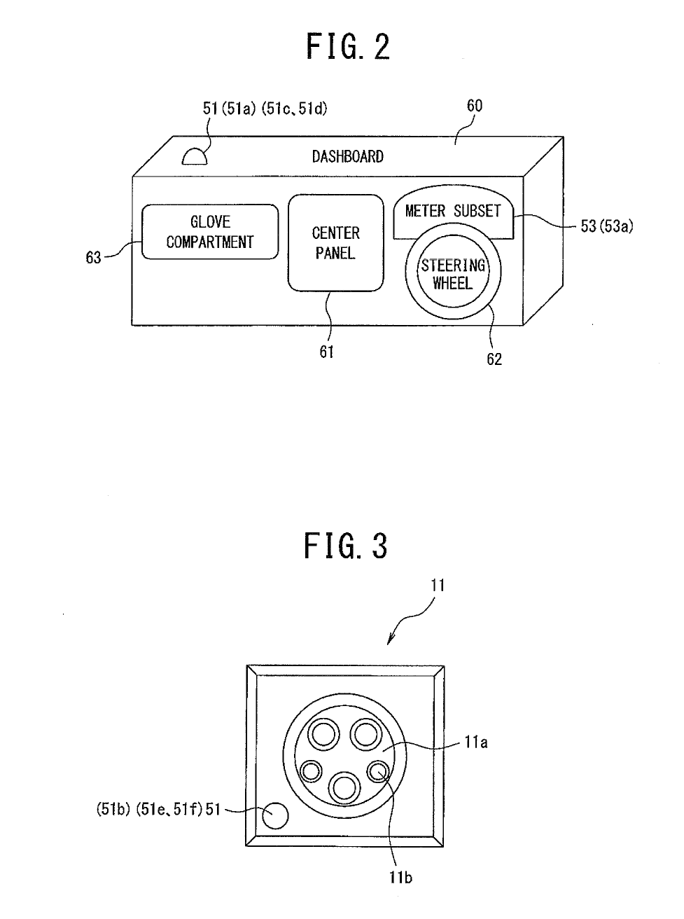

FIG. 2 and FIG. 3 show examples of elements of the indicator set 51 arranged to the vehicle. As shown in FIG. 2, the indicator set 51 includes an indicator 51a disposed in a left area at an upside of a dashboard 60 in the vehicle interior. The dashboard 60 additionally has a center panel 61, a subset 53a of the meter set 53 including a speedometer, and a steering wheel 62 arranged thereto. The dashboard 60 is provided with a glove compartment 63. As shown in FIG. 3, the indicator set 51 includes an indicator 51b disposed at an outside of (i.e. in an exposed area about) a receptacle aperture 11a that is provided at the charge port 11 for the charge plug 210 to be inserted thereto after displacement of an outer cover of the charge port 11 exposed outside the vehicle. The receptacle aperture 11a has polarity alignment holes 11b formed at a bottom thereof, for receiving polarity alignment pins provided at the charge plug 210 for a click-in thereto. The alignment pins are arranged to fit in the alignment holes 11b, ensuring a standard-compliant connection between the charge plug 210 and the charge port 11. This condition is represented by a click signal that is transmitted to the charger 12, via the communication system including the communication line 110. It is noted that the click signal may be substituted by an optical communication signal between optical fibers provided at the charge plug 210 and the charge port 11, respectively.

The indicators 51a and 5b are each respectively disposed at a location on the vehicle body where it can be visually recognized by persons standing outside the vehicle. It is noted that in embodiments concerning any one of FIG. 1 through FIG. 13, the indicator set 51 may have a subset thereof (e.g. the indicator 51a or the indicator 51b) located at an interior of or at an outside of the vehicle.

The information input interface set 52 includes interface elements operable by an occupant to input various pieces of information. The information input interface set 52 has subsets thereof provided at locations including those on the center panel 61 and the steering wheel 62, for instance. The information input interface set 52 is composed of interface elements each adapted to output input information through the CAN communication line 110 to the meter controller 54.

The meter controller 54 has functions involving those for various processing items including items for processes to be executed on bases of pieces of information input from the information input interface set 52, and those for actions to control subsets of the indicator set 51 and subsets of the meter set 53 to be driven. The meter controller 54 has a clock function for a current clock time to be grasped, as well. For instance, the meter controller 54 may include a microcomputer and peripheries thereof. For instance, the meter controller 54 may be composed of an ECU including a CPU, a ROM, a RAM, etc.

The vehicle controller 70 is adapted for overall control of the vehicle. The vehicle controller 70 is connected to the CAN communication line 110, for communications such as those with the battery controller 19, the A/C controller 33, and the meter controller 54. For instance, the vehicle controller 70 may include a microcomputer and peripheries thereof. For instance, the vehicle controller 70 may be composed of an ECU including a CPU, a ROM, a RAM, etc.

According to embodiments concerning any one of FIG. 1 through FIG. 13, there is a vehicle provided with such a system configuration as described.

According to embodiments concerning any one of FIG. 1 through FIG. 13, the vehicle system 1 has a charge service reserving function and an air-conditioning service reserving function. With the charge service reserving function, the vehicle system 1 is adapted to receive a reservation for a charge service including a charge start time. The vehicle system 1 is then adapted to operate, when the clock gets the reserved charge start time, to enter a series of processing items to be implemented at the vehicle end, as necessary for the reserved charge service. With the air-conditioning service reserving function, the vehicle system 1 is adapted to receive reservations for air-conditioning services including a preliminary air-conditioning service with a designated preliminary air-conditioning start time. The vehicle system 1 is then adapted to operate, when the clock gets the designated preliminary air-conditioning start time, to enter a series of processing items to be implemented at the vehicle end, as necessary for the reserved air-conditioning service.

Description is now made of contents of the processing items to be implemented in accordance with the charge service reserving function and the air-conditioning service reserving function.

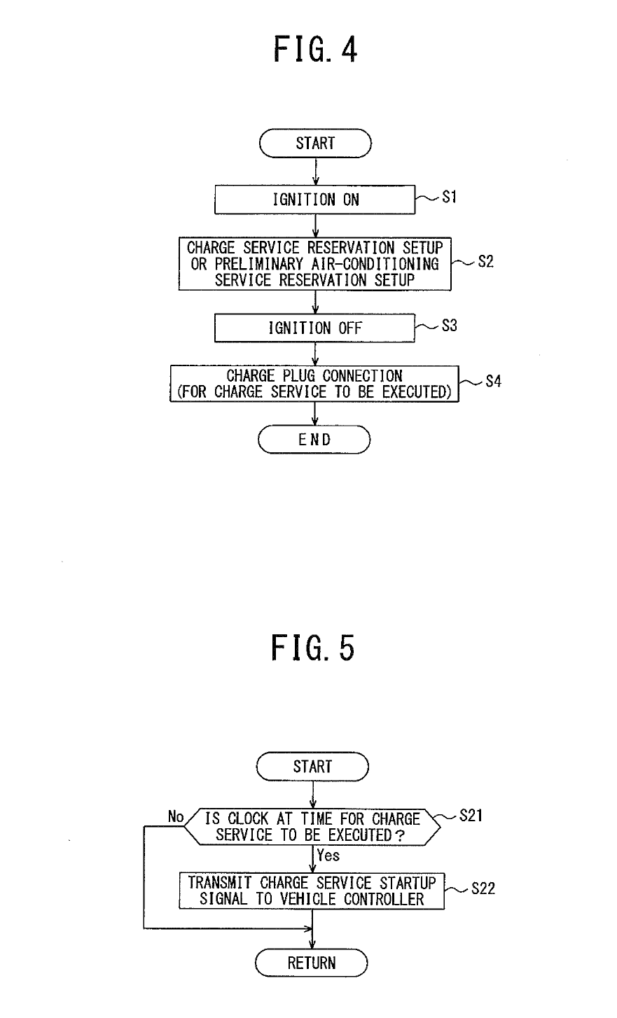

FIG. 4 shows an exemplary task sequence to be followed by a user (e.g. by an occupant) until connection of a charge plug 210 to the charge port 11, involving tasks for a reservation of a charge service to be set up inclusive of setting a charge start time, and/or tasks for one or more reservations of air-conditioning services including a reservation of a preliminary air-conditioning service to be set up inclusive of setting a preliminary air-conditioning start time. It is noted that for air-conditioning services excluding the preliminary air-conditioning service, there are conventional tasks to be done for their reservations, which are omitted for description easy to understand.

As shown in FIG. 4, first at a step S1, the user turns on an ignition that is a starter switch of the vehicle.

Then, at a step S2, the user operates a subset of the information input interface set 52 (for instance, a bank of dedicated reservation switches) for setups including those of the charge service reservation and the preliminary air-conditioning service reservation. In other words, the user may operate elements in the information input interface set 52, to thereby input pieces of information for a reservation of a charge service, such as a charge start time, as necessary to set up the charge service reservation. The user may operate elements in the information input interface set 52, to thereby input pieces of information for a reservation of a preliminary air-conditioning service, such as a preliminary air-conditioning start time, as necessary to set up the preliminary air-conditioning service reservation. There are pieces of data on information input for reservations of services to be set up, including those of the charge service and the preliminary air-conditioning service, which are stored as reservation setup data in memories including those provided at the meter controller 54 and the vehicle controller 70.

After that, at a step S3, the user turns the ignition off. Then, at a step S4, the user operates the charge plug 210 to insert into the charge port 11, for a connection thereto to establish a charge permitting condition.

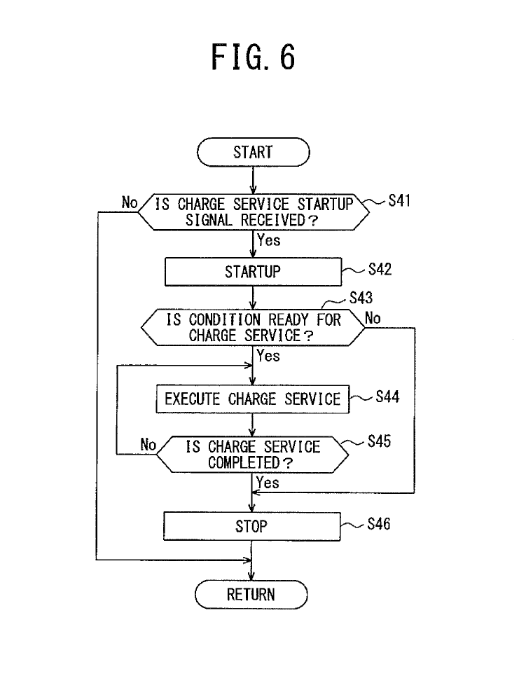

FIG. 5 and FIG. 6 show examples of flowcharts for processing items including those to be implemented at the meter controller 54 and the vehicle controller 70. Shown in FIG. 5 is a flowchart for items of processing to be implemented at the meter controller 54, and FIG. 6 is a flowchart for items of processing to be implemented at the vehicle controller 70.

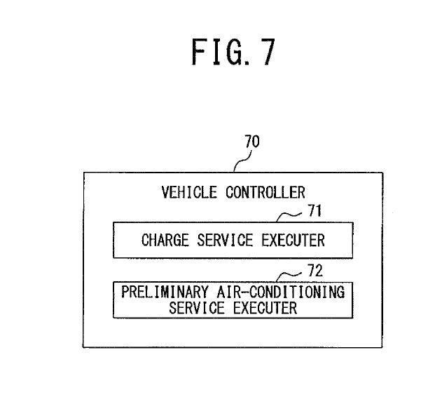

FIG. 7 shows an example of configuration of the vehicle controller 70 adapted to implement the processing shown in FIG. 6. As shown in FIG. 7, the vehicle controller 70 includes a charge service executer 71, and a preliminary air-conditioning service executer 72. At the vehicle controller 70, those parts shown in FIG. 7 are adapted for particulars of processing items to be described with reference to procedures of processing in associated flowcharts.

As shown in FIG. 5, first at a step S21, the meter controller 54 determines whether or not the clock is at a time for a charge service to be executed. More specifically, the meter controller 54 determines whether or not a current clock timed by the clock function is at a time set up to start execution of a charge service, as it is reserved and stored in a memory. The meter controller 54 gives a decision of affirmation when the clock is at the time for the charge service to be executed. With the decision, the meter controller 54 goes to a step S22.

At the step S22, the meter controller 54 transmits a charge service startup signal (as a startup request) via the CAN communication line 110 to the vehicle controller 70. Then, the meter controller 54 goes to an end of the processing shown in FIG. 5.

On the other hand, as shown in FIG. 6, the vehicle controller 70 operates first at a step S41 to determine whether or not it has received any charge service startup signal (as a startup request) from the meter controller 54. The vehicle controller 70 goes to a step S42, when having determined it has received a charge service startup signal from the meter controller 54. Or else, the vehicle controller 70 goes to an end of the processing shown in FIG. 6, when having determined it has received no charge service startup signal from the meter controller 54.

At the step S42, the vehicle controller 70 makes the charge service executer 71 start operating. In other words, as shown in FIG. 6, it makes a routine of actions (including steps S43 to S45) at the charge service executer 71 interrupt a routine of actions at the vehicle controller 70 (i.e., between a start and a return with the step S41 in between).

Then, at a step S43, the charge service executer 71 determines whether or not the charge port 11 is put in a condition ready for a charge service. In other words, the charge service executer 71 determines whether or not the charge plug 210 is connected to the charge port 11. If the charge port 11 is put in a condition ready for a charge service, the charge service executer 71 goes to a step S44. Unless the charge port 11 is put in a condition ready for a charge service, the charge service executer 71 goes to a step S46.

At the step S44, the charge service executer 71 executes the charge service to the high-voltage battery set 15. More specifically, the charge service executer 71 transmits a charge permission command via the CAN communication line 110 to the charger 12. The charger 12, having received the charge permission command, starts charging the high-voltage battery set 15. The charger 12 is adapted to transmit information on a condition of charge at the high-voltage battery set 15, via the CAN communication line 110 to the vehicle controller 70, over duration of the charge service being executed.

At a step S45, the charge service executer 71 determines whether or not the charge service is completed. Here, the charge service executer 71 is adapted to determine a charge service is completed when the clock is at a preset time for completion of the charge service. The charge service executer 71 may be adapted to determine a charge service is completed when it has determined that the high-voltage battery set 15 should be at a saturated state of charge on the basis of information on the condition of charge transmitted from the charger 12. The charge service executer 71, having determined the charge service is completed, goes to the step S46.

At the step S46, the vehicle controller 70 makes the charge executer 71 stop (to put in a waiting state, for instance). Then, as shown in FIG. 6, the vehicle controller 70 returns from the routine of actions at the charge executer 71 to the routine of actions at the vehicle controller 70. Those processing items shown in FIG. 5 and FIG. 6 are implemented as described.

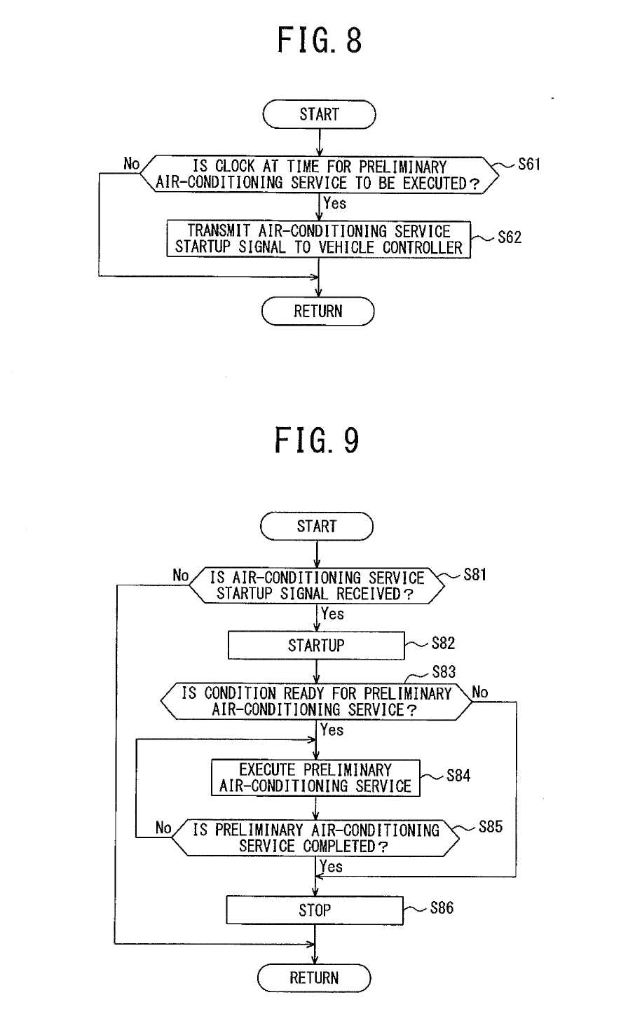

FIG. 8 and FIG. 9 show examples of flowcharts for processing items including those to be implemented at the meter controller 54 and the vehicle controller 70. Shown in FIG. 8 is a flowchart for items of processing to be implemented at the meter controller 54, and FIG. 9 is a flowchart for items of processing to be implemented at the vehicle controller 70.

As shown in FIG. 8, first at a step S61, the meter controller 54 determines whether or not the clock is at a time for a preliminary air-conditioning service to be executed. More specifically, the meter controller 54 determines whether or not a current clock timed by the clock function is at a time set up to start execution of a preliminary air-conditioning service, as it is reserved and stored in a memory. The meter controller 54 gives a decision of affirmation when the clock is at the time for the preliminary air-conditioning service to be executed. With the decision, the meter controller 54 goes to a step S62.

At the step S62, the meter controller 54 transmits a startup signal (as a startup request) for the preliminary air-conditioning service via the CAN communication line 110 to the vehicle controller 70. Then, the meter controller 54 goes to an end of the processing shown in FIG. 8.

On the other hand, as shown in FIG. 9, the vehicle controller 70 operates first at a step S81 to determine whether or not it has received any startup signal from the meter controller 54 (as a startup request) for the preliminary air-conditioning service. The vehicle controller 70 goes to a step S82, when having determined it has received a startup signal from the meter controller 54 for the preliminary air-conditioning service. Or else, the vehicle controller 70 goes to an end of the processing shown in FIG. 9, when having determined it has received no startup signal from the meter controller 54 for the preliminary air-conditioning service.

At the step S82, the vehicle controller 70 makes the preliminary air-conditioning service executer 72 start operating. In other words, as shown in FIG. 9, it makes a routine of actions (including steps S83 to S85) at the preliminary air-conditioning service executer 72 interrupt a routine of actions at the vehicle controller 70 (i.e., between a start and a return with the step S81 in between).

Then, at a step S83, the preliminary air-conditioning service executer 72 determines whether or not the air-conditioning system 30 is put in a condition ready for a preliminary air-conditioning service. The air-conditioning system 30 is adapted to provide preliminary air-conditioning services when the charge port 11 is put in a condition ready for charge services. Therefore, the preliminary air-conditioning service executer 72 determines whether or not the charge port 11 is put in a condition ready for a charge service, to thereby determine whether or not the air-conditioning system 30 is put in a condition ready for the preliminary air-conditioning service. In other words, the preliminary air-conditioning service executer 72 determines whether or not the charge plug 210 is connected to the charge port 11, to thereby determine whether or not the air-conditioning system 30 is put in a condition ready for the preliminary air-conditioning service. If the air-conditioning system 30 is put in a condition ready for the preliminary air-conditioning service, the preliminary air-conditioning service executer 72 goes to a step S84. Unless the air-conditioning system 30 is put in a condition ready for the preliminary air-conditioning service, the preliminary air-conditioning service executer 72 goes to a step S86.

At the step S84, the preliminary air-conditioning service executer 72 executes the preliminary air-conditioning service. More specifically, the preliminary air-conditioning service executer 72 transmits a preliminary air-conditioning permission command via the CAN communication line 110 to the A/C controller 33. The A/C controller 33, having received the preliminary air-conditioning permission command, starts operation to provide the preliminary air-conditioning service.

At a step S85, the preliminary air-conditioning service executer 72 determines whether or not the preliminary air-conditioning service is completed. Here, the preliminary air-conditioning service executer 72 is adapted to determine a preliminary air-conditioning service is completed when the clock is at a preset time for completion of the preliminary air-conditioning service having been set up as it has been reserved by e.g. the user (that may be a preset clock time for departure of the vehicle, for instance). It is noted that, at the vehicle controller 70, the startup signal having been received at the step S62 (as a startup request) for the preliminary air-conditioning service from the meter controller 54 is accompanied by reservation setup data involving a time preset for completion of the preliminary air-conditioning service, which is based on for the preliminary air-conditioning service executer 72 to determine whether or not the preliminary air-conditioning service is completed (that is, whether or not the clock is at the time preset for completion of the preliminary air-conditioning service. The preliminary air-conditioning service executer 72, having determined the preliminary air-conditioning service is completed, goes to the step S86.

At the step S86, the vehicle controller 70 makes the preliminary air-conditioning executer 72 stop (to put in a waiting state, for instance). Then, as shown in FIG. 9, the vehicle controller 70 returns from the routine of actions at the preliminary air-conditioning service executer 72 to the routine of actions at the vehicle controller 70. Those processing items shown in FIG. 8 and FIG. 9 are implemented as described.

Description is now made of exemplary modes of lighting control to be executed for the indicator set 51 after reservation of a charge service and during execution of the charge service, as well as those after reservation of a preliminary air-conditioning service and during execution of the preliminary air-conditioning service.

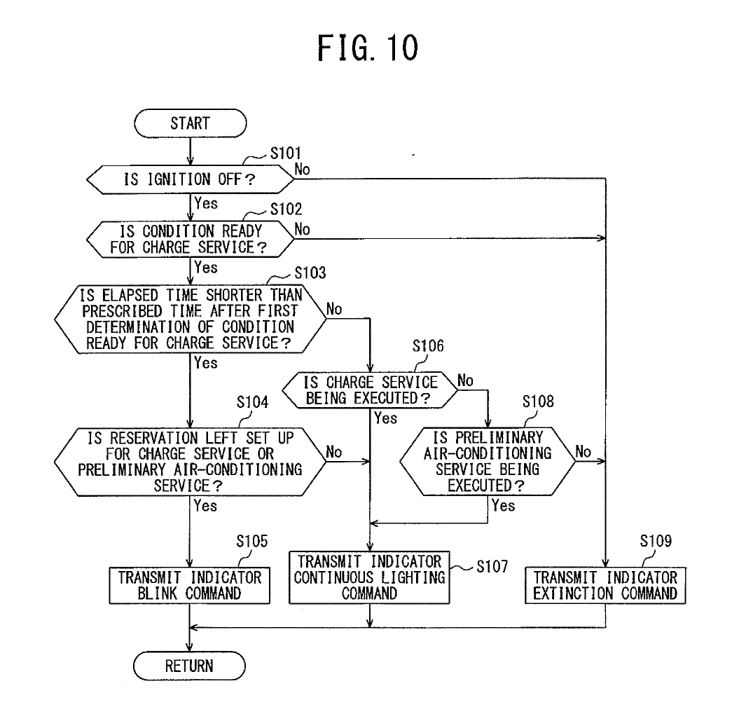

FIG. 10 shows, in a flowchart, items of processing to be implemented at the meter controller 54 in a mode of lighting control for the indicator set 51.

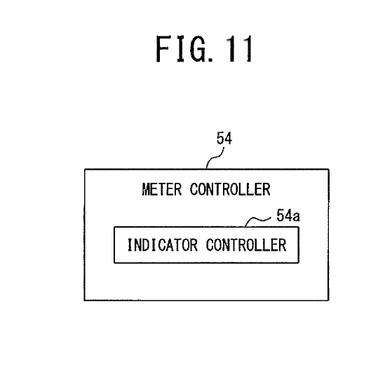

FIG. 11 shows a configuration of the meter controller 54 adapted to implement items of processing shown in FIG. 10. As shown in FIG. 11, the meter controller 54 includes an indicator controller 54a. The indicator controller 54a shown in FIG. 11 is adapted for particulars of processing items to be described with reference to FIG. 10 showing procedures of processing in the flowchart.

As shown in FIG. 10, first at a step S101, the indicator controller 54a operates to determine whether or not the ignition is put in an off state, on the basis of information on a state of the ignition that the vehicle controller 70 has received from a detection element (e.g. a contact set at the starter switch) detecting a state of the ignition. If the ignition is in the off state, the indicator controller 54a goes to a step S102. Unless the ignition is in the off state (that is, if the ignition is put in an on state), the indicator controller 54a goes to a step S109. It is noted that the indicator controller 54a or the meter controller 54 may directly acquire, from the detection element, a piece of information on a result of detection about a state of the ignition.

At the step S109, the indicator controller 54a outputs “an indicator control command for rendering extinct a principal subset of the indicator set 51 (including e.g. the indicator 51a or the indicator 51b) associated with plug-in charge and preliminary air-conditioning services” (referred herein to as an indicator extinction command), whereby the principal subset of the indicator set 51 is made extinct. Then, the indicator controller 54a goes to an end of the processing shown in FIG. 10.

At the step S102, the indicator controller 54a operates to determine whether or not the charge port 11 is put in a condition ready for a charge service, on the basis of information on a condition of use of the charge port 11 that the vehicle controller 70 has received from a detection element (e.g. a switch contact set in the alignment holes 11b) detecting a condition of use of the charge port 11. More specifically, the indicator controller 54a is adapted to determine whether or not a charge plug 210 is connected to the charge port 11, to thereby determine whether or not the charge port 11 is put in a condition ready for a charge service. If the charge port 11 is put in a condition ready for a charge service, the indicator controller 54a sets or holds on a timer on-off flag for a software timer (that is adapted to time an elapsed time while the timer is on), and goes to a step S103. Unless the charge port 11 is put in a condition ready for a charge service (that is, if the charge port 11 has no charge plug 210 connected thereto), the indicator controller 54a simply goes to the step S109. It is noted that the indicator controller 54a or the meter controller 54 may directly acquire, from the detection element, a piece of information on a result of detection about a condition of use of the charge port 11.

At the step S103, the indicator controller 54a determines whether or not a prescribed interval of time has not yet been elapsed after a condition established to be ready for a charge service has been first determined at the step S102 (that is, whether or not an elapsed time on the software timer is shorter than a prescribed time). The prescribed time is preset as a blink execution interval for blinking a subset of the indicator set 51 to indicate presence of a service or services reserved for charge or air-conditioning. Therefore, the indicator controller 54a as well as equipment in the vehicle system 1 communicating therewith may not accept any reservation to be set for a charge or preliminary air-conditioning service with a start clock time exceeding a sum of a current clock time, a preset waiting time, and the prescribed time. The prescribed time is predetermined in an empirical, experimental or theoretical manner. The indicator controller 54a goes to a step S104, when having determined that the prescribed time has not yet been elapsed after a condition ready for a charge service has been first determined (that is, if the elapsed time on the software timer is shorter than the prescribed time). The indicator controller 54a goes to a step S106, when having determined that the prescribed time has been elapsed after a condition ready for a charge service has been first determined (that is, if the elapsed time on the software timer is equal to or longer than the prescribed time).

At the step S104, the indicator controller 54a determines whether or not a reservation is left set up for a certain charge service or preliminary air-conditioning service. The indicator controller 54a goes to a step S105, when having determined that a reservation is left set up for a charge service or for a preliminary air-conditioning service. The indicator controller 54a goes to a step S107, when having determined that no reservation is left set up for any charge service or preliminary air-conditioning service.

At the step S105, the indicator controller 54a outputs “an indicator control command for blinking the principal subset of the indicator set 51” (referred herein to as an indicator blink command), whereby the principal subset of the indicator set 51 is caused to blink. Here, the indicator controller 54a is adapted to have the principal subset of the indicator set 51 blink at a prescribed period. Then, the indicator controller 54a goes to an end of the processing shown in FIG. 10.

At the step S106, the indicator controller 54a determines whether or not a charge service is being executed. The indicator controller 54a goes to the step S107, when having determined that a charge service is being executed. The indicator controller 54a goes to a step S108, when having determined that no charge service is being executed, that is, when no charge service is executed at the charge port 11 to which a charge plug 210 has already been connected.

At the step S107, the indicator controller 54a outputs “an indicator control command for having the principal subset of the indicator set 51 lighting, more specifically, continuously lighting” (referred herein to as an indicator continuous lighting command), whereby the principal subset of the indicator set 51 is kept lit. Then, the indicator controller 54a goes to an end of the processing shown in FIG. 10.

At the step S108, the indicator controller 54a determines whether or not a preliminary air-conditioning service is being executed. The indicator controller 54a goes to the step S107, when having determined that a preliminary air-conditioning service is being executed, that is, when simply the preliminary air-conditioning service is executed, involving no charge service being executed. The indicator controller 54a goes to the step S109, when having determined that no preliminary air-conditioning service is being executed, that is, when neither charge service nor preliminary air-conditioning service is executed at the charge port 11 to which a charge plug 210 has already been connected. When going from the step S108 to the step S109, the indicator controller 54a turns the timer on-off flag off, whereby the software timer is reset to the state of a count zero. Those processing items shown in FIG. 10 are implemented as described.

### Actions and Effects

Description is now made of a series of actions and effects at the vehicle system 1 according to embodiments concerning any one of FIG. 1 through FIG. 13. At the vehicle system 1, any user having turned the ignition on can enter operations for setups including those of a charge service reservation and a preliminary air-conditioning service reservation (at the step S1 and the step S2). The vehicle system 1 thus has pieces of reservation setup data involving those of a charge start time and a preliminary air-conditioning start time that have been set up along with the setup of the charge service reservation and the setup of the preliminary air-conditioning service reservation, which are stored in memories including those provided at the meter controller 54 and the vehicle controller 70. At the vehicle system 1 in such a situation, the user having completed setups including those of the charge service reservation and the preliminary air-conditioning service reservation can turn the ignition off, to enter operations for connecting a charge plug 210 to the charge port 11 (at the step S3 and the step S4).

In due course, at the vehicle system 1, there is a determination made at the meter controller 54 based on the charge start time set up in advance, such that a clock has got to a time for a charge service to be executed, whereby (the charge service executer 71 being) part of the vehicle controller 70 is called to start. This part of the vehicle controller 70 serves for a processing under a charge permitting condition (at the charge port 11) to transmit a charge permission command from the vehicle controller 70 to the charger 12, to start execution of the charge service for a charge from the charge plug 210. Afterward, at the vehicle system 1, the charge service is completed such as when the clock has got to a charge completion time, whereby that part of the vehicle controller 70 is stopped (refer to FIG. 5 and FIG. 6).

Further, at the vehicle system 1, there is a determination made at the meter controller 54 based on the preliminary air-conditioning start time set up in advance, such that the clock has got to a time for a preliminary air-conditioning service to be executed, whereby (the preliminary air-conditioning service executer 72 being) part of the vehicle controller 70 is called to start. This part of the vehicle controller 70 serves for a processing under a preliminary air-conditioning permitting condition (that is, under a charge permitting condition at the charge port 11 in embodiments concerning any one of FIG. 1 through FIG. 13) to transmit a preliminary air-conditioning permission command from the vehicle controller 70 to the A/C controller 33, to start execution of the preliminary air-conditioning service. Afterward, at the vehicle system 1, the preliminary air-conditioning service is completed such as when the clock has got to a preliminary air-conditioning completion time, whereby that part of the vehicle controller 70 is stopped (refer to FIG. 8 and FIG. 9).

On the other hand, at the vehicle system 1, the indicator set 51 has a subset thereof (including e.g. the indicator 51a or 5b) put under a lighting control for one of the following patterns of actions, after the charge service reservation or during the charge service as well as after the preliminary air-conditioning service reservation or during the preliminary air-conditioning service.

At the vehicle system 1 with the ignition in the on state, the indicator set 51 has the subset thereof rendered extinct (at the step S101 and the step S109).

At the vehicle system 1 with the ignition in the off state, if the reservation of the charge service or the reservation of the preliminary air-conditioning service is in a setup state, the indicator set 51 has the subset thereof blinking within a prescribed time after a connection of the charge plug 210 to the charge port 11 (at processing items including the step S101 through the step S105).

At the vehicle system 1 with the ignition in the off state, if neither the reservation of the charge service nor the reservation of the preliminary air-conditioning service is left set up, the indicator set 51 has the subset thereof continuously lit even within the prescribed time after the connection of the charge plug 210 to the charge port 11 (at processing items including the step S101 through the step S104, and the step S107). At the vehicle system 1 with the ignition in the off state, even when the prescribed time has elapsed since the connection of the charge plug 210 to the charge port 11, the indicator set 51 has the subset thereof continuously lit, if the charge service or the preliminary air-conditioning service is being executed (at processing items including the step S101 through the step S103, and processing items from the step S106 or the step S108 to the step S107).

At the vehicle system 1 with the ignition in the off state, if neither the charge service nor the preliminary air-conditioning service is being executed (for instance, if the charge service executer 71 and the preliminary air-conditioning service executer 72 are in their waiting states) the indicator set 51 has the subset thereof rendered extinct, when the prescribed time has elapsed since the connection of the charge plug 210 to the charge port 11 (at processing items including the step S101 through the step S103, and processing items including the step S106, the step S108, and the step S109).

The vehicle system 1, operable as described, is adapted to have a subset of the indicator set 51 blink in prescribed periods for a prescribed interval, by connecting a charge plug 210 to the charge port 11 after a reservation set up for a charge or preliminary air-conditioning service. Without any charge plug 210 connected to the charge port 11, the subset of the indicator set 51 will not be blinked nor lit, even after a setup of reservation for a charge or preliminary air-conditioning service. Such actions at the subset of the indicator set 51 permit users to be successful without forgetting connection of a charge plug 210 to the charge port 11, after the setup of reservation for a charge or preliminary air-conditioning service. The vehicle system 1 thus allows for an ensured start of the charge or preliminary air-conditioning service at a clock time set up as reserved.

Such being the case, the vehicle system 1 affords for an enhanced user-friendliness, avoiding errors in user's recognition about vehicle conditions.

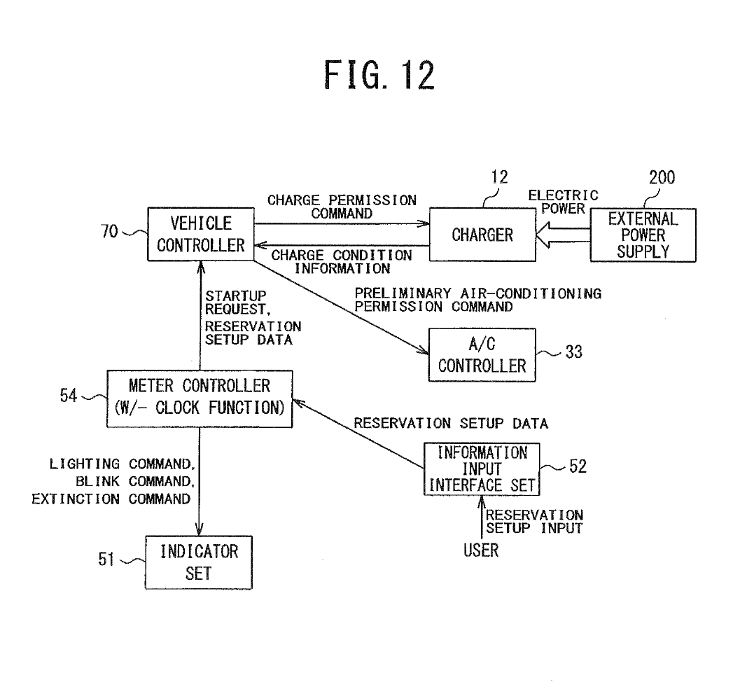

FIG. 12 shows exemplary communications including those of various pieces of information at the vehicle system 1. As shown in FIG. 12, at the vehicle system 1, the information input interface set 52 has a subset thereof operable for a user to input data on services including a charge service or a preliminary air-conditioning service to be set up for their reservations, the data being transmitted from the subset of the information input interface set 52 to the meter controller 54, as reservation setup data including pieces of data involving those on a clock time to start the charge service or on a clock time to start the preliminary air-conditioning service.

At the vehicle system 1, when a clock has got to a time for the charge service to be executed or to a time for the preliminary air-conditioning service to be executed, the meter controller 54 operates to transmit a startup request (as a charge service startup signal or as a preliminary air-conditioning service startup signal) involving reservation setup data, to the vehicle controller 70. In response thereto, the vehicle controller 70 operates if the startup request received is for the charge service to be executed, to transmit a charge permission command to the charger 12. The charger 12 is thereby operated to start the charge service, and transmit to the vehicle controller 70 data of information on a condition of charge at the high-voltage battery set 15 being supplied with electric power from an external power supply 200. The vehicle controller 70 operates if the startup request received is for the preliminary air-conditioning service to be executed, to transmit a preliminary air-conditioning permission command to the A/C controller 33.

At the vehicle system 1, the meter controller 54 is adapted to transmit subsets of an indicator control command set to the indicator set 51, involving a continuous lighting command, a blink command, or an extinction command to the subset of the indicator set 51, as necessary, for indications of currently concerned subsets of a set of vehicle conditions including those of reservations set up for services such as a charge service or a preliminary air-conditioning service, and those of execution of services such as a charge service or a preliminary air-conditioning service.

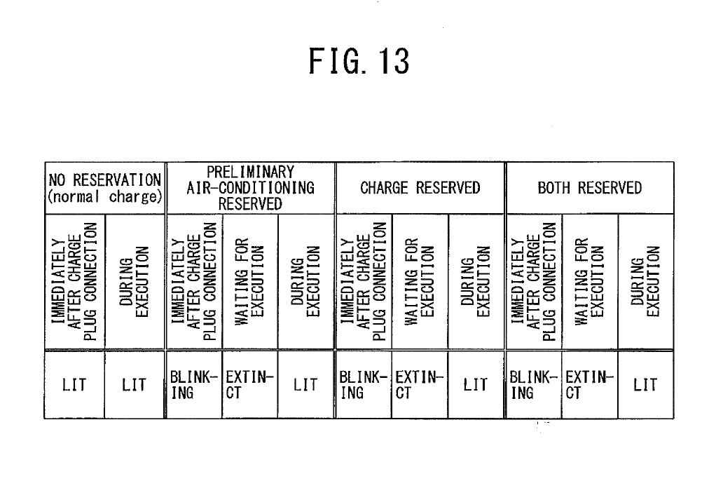

FIG. 13 shows exemplary patterns of indicator actions at the subset of the indicator set 51 under control by the indicator controller 54a. As shown in FIG. 13, under subsets of the vehicle condition set with no reservation of charge service or preliminary air-conditioning service set up (i.e., for a normal charge service), the subset of the indicator set 51 is lit (at the step S107) “immediately after a charge plug 210 is connected to the charge port 11” (referred herein to as “immediately after charge plug connection”), and kept lit (at the step S107) during execution of the charge service.

Under subsets of the vehicle condition set with a reservation set up for a preliminary air-conditioning service, the subset of the indicator set 51 blinks (at the step S105) for a prescribed interval immediately after charge plug connection, and afterward (at the step S109) gets extinct. It is noted that the subset of the indicator set 51 is kept lit (at the step S107) during execution of the preliminary air-conditioning service to be performed as set up in the reservation.

Under subsets of the vehicle condition set with a reservation set up for a charge service, the subset of the indicator set 51 blinks (at the step S105) for the prescribed interval immediately after charge plug connection, and afterward (at the step S109) gets extinct. It is noted that the subset of the indicator set 51 is kept lit (at the step S107) during execution of the charge service to be performed as set up in the reservation.

Under subsets of the vehicle condition set with reservations set up for a preliminary air-conditioning service and a charge service, as well, the subset of the indicator set 51 blinks (at the step S105) for the prescribed interval immediately after charge plug connection, and afterward (at the step S109) gets extinct. It is noted that the subset of the indicator set 51 is kept lit (at the step S107) during execution of the preliminary air-conditioning service or the charge service to be performed alone or in combination as set up in the reservations.

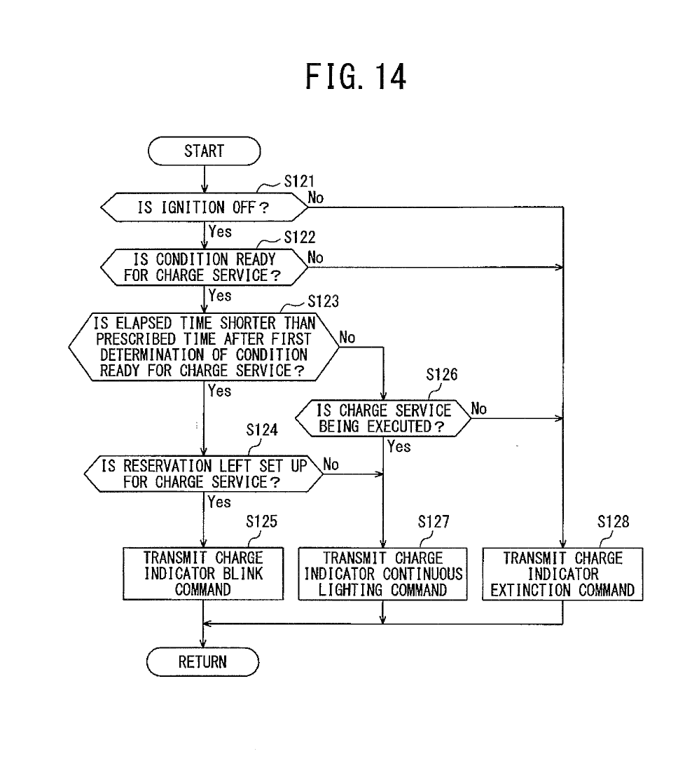

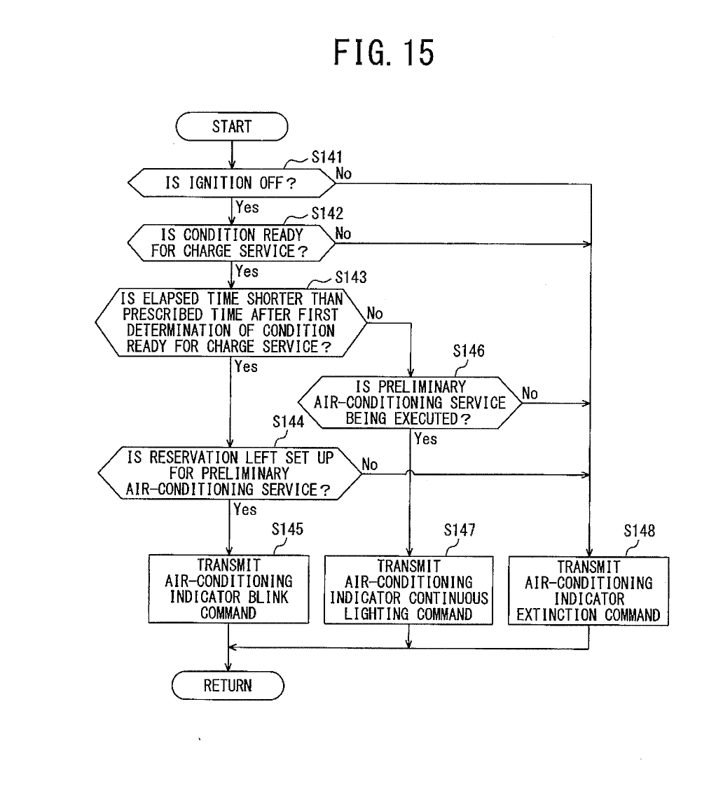

### Embodiments Concerning FIG. 14 or FIG. 15

Description is now made of embodiments concerning FIG. 14 or FIG. 15, with reference being made to FIG. 14 and FIG. 15 as well as to FIG. 2 and FIG. 3. Relative to embodiments concerning any one of FIG. 1 through FIG. 13, like constituent elements are designated at like reference signs in FIG. 14 or FIG. 15, omitting redundant description.

According to embodiments concerning FIG. 14 or FIG. 15, there is a vehicle system 1 provided with an indicator set 51 including as subsets thereof a set of charge indicators for informing pieces of information on a subset of the vehicle condition set associated with charge services and a set of air-conditioning indicators for informing pieces of information on a subset of the vehicle condition set associated with preliminary air-conditioning services. At the vehicle system 1 including subsets of the indicator set 51 shown in FIG. 2 and FIG. 3, the set of charge indicators and the set of air-conditioning indicators are composed of combinations of indicator elements (referred herein to sometimes simply as indicators) {51c, 51e} and {51d, 51f}, respectively, as they are selected from among elements 51c and 51d of a set of indicator elements being parallel-arrayed or sub-divided elements of an element 51a constituting a subset of the indicator set 51 in FIG. 2 and elements 51e and 51f of a set of indicator elements being parallel-arrayed or sub-divided elements of an element 51b constituting a subset of the indicator set 51 in FIG. 3. Those indicator elements 51c and 51e constituting the charge indicator set have an illumination color different from an illumination color of those indicator elements 51d and 51f constituting the air-conditioning indicator set. In other words, according to embodiments concerning FIG. 14 or FIG. 15, there is a vehicle system 1 including, as individual sets, a set of charge indicators 51c and 51e for informing pieces of information on conditions concerning charge services and a set of air-conditioning indicators 51d and 51f for informing pieces of information on conditions concerning preliminary air-conditioning services. At the vehicle system 1, for instance, the indicators 51a and 51b shown in FIG. 2 or FIG. 3 may be parallel-arrayed or sub-divided to provide sets of indicators 51c, 51d and 51e, 51f, and/or color-coded with pairs of different illumination colors to provide sets of indicators 51c, 51d and 51e, 51f, to thereby individually implement the set of charge indicators 51c and 51e and the set of air-conditioning indicators 51d and 51f. The vehicle system 1 is provided with a meter controller 54 (refer to FIG. 1) involving an indicator controller 54a (refer to FIG. 11) adapted to individually control elements of the indicator set 51 including the charge indicators 51c and 51e and the air-conditioning indicators 51d and 51f.

FIG. 14 shows, in a flowchart, items of processing to be implemented at the indicator controller 54a in a mode of lighting control for the charge indicator set.

As shown in FIG. 14, first at a step S121, the indicator controller 54a operates to determine whether or not an ignition being a starter switch is put in an off state, on the basis of information on a state of the ignition that a vehicle controller 70 (refer to FIG. 1) has received from a detection element (e.g. a contact set at the starter switch) detecting a state of the ignition. If the ignition is in the off state, the indicator controller 54a goes to a step S122. Unless the ignition is in the off state (that is, if the ignition is put in an on state), the indicator controller 54a goes to a step S128.

At the step S128, the indicator controller 54a outputs “an indicator control command for rendering extinct the set of charge indicators 51c and 51e (referred herein to as a charge indicator extinction command), whereby the charge indicator set is made extinct. Then, the indicator controller 54a goes to an end of the processing shown in FIG. 14.

At the step S122, the indicator controller 54a operates to determine whether or not a charge port 11 shown in FIG. 3 is put in a condition ready for a charge service, on the basis of information on a condition of use of the charge port 11 that the vehicle controller 70 has received from a detection element (e.g. a switch contact set in alignment holes 11b in FIG. 3) detecting a condition of use of the charge port 11. More specifically, the indicator controller 54a is adapted to determine whether or not a charge plug 210 (refer to FIG. 1) is connected to the charge port 11, to thereby determine whether or not the charge port 11 is put in a condition ready for a charge service. If the charge port 11 is put in a condition ready for a charge service, the indicator controller 54a sets or holds on a timer on-off flag for a software timer (that is adapted to time an elapsed time while the timer is on), and goes to a step S123. Unless the charge port 11 is put in a condition ready for a charge service (that is, if the charge port 11 has no charge plug 210 connected thereto), the indicator controller 54a simply goes to the step S128.

At the step S123, the indicator controller 54a determines whether or not a prescribed interval of time has not yet been elapsed after a condition established to be ready for a charge service has been first determined at the step S122 (that is, whether or not an elapsed time on the software timer is shorter than the prescribed time). The indicator controller 54a goes to a step S124, when having determined that the prescribed time has not yet been elapsed after a condition ready for a charge service has been first determined (that is, if the elapsed time on the software timer is shorter than the prescribed time). The indicator controller 54a goes to a step S126, when having determined that the prescribed time has been elapsed after a condition ready for a charge service has been first determined (that is, if the elapsed time on the software timer is equal to or longer than the prescribed time).

At the step S124, the indicator controller 54a determines whether or not a reservation is left set up for a certain charge service. The indicator controller 54a goes to a step S125, when having determined that a reservation is left set up for a charge service. The indicator controller 54a goes to a step S127, when having determined that no reservation is left set up for any charge service.

At the step S125, the indicator controller 54a outputs “an indicator control command for blinking the set of charge indicators 51c and 51e” (referred herein to as a charge indicator blink command), whereby the charge indicator set is caused to blink. Then, the indicator controller 54a goes to an end of the processing shown in FIG. 14.

At the step S126, the indicator controller 54a determines whether or not a charge service is being executed. The indicator controller 54a goes to the step S127, when having determined that a charge service is being executed. The indicator controller 54a goes to the step S128, when having determined that no charge service is being executed, that is, when no charge service is executed at the charge port 11 to which a charge plug 210 has already been connected. When going from the step S126 to the step S128, the indicator controller 54a turns the timer on-off flag off, whereby the software timer is reset to the state of a count zero.

At the step S127, the indicator controller 54a outputs “an indicator control command for having the set of charge indicators 51c and 51e lighting, more specifically, continuously lighting” (referred herein to as a charge indicator continuous lighting command), whereby the charge indicator set is kept lit. Then, the indicator controller 54a goes to an end of the processing shown in FIG. 14.

FIG. 15 shows, in a flowchart, items of processing to be implemented at the indicator controller 54a in a mode of lighting control for the air-conditioning indicator set.

As shown in FIG. 15, first at a step S141, the indicator controller 54a operates to determine whether or not the ignition is put in an off state, on the basis of information on a state of the ignition that the vehicle controller 70 has received from the detection element detecting a state of the ignition. If the ignition is in the off state, the indicator controller 54a goes to a step S142. Unless the ignition is in the off state (that is, if the ignition is put in an on state), the indicator controller 54a goes to a step S148.

At the step S148, the indicator controller 54a outputs “an indicator control command for rendering extinct the set of air-conditioning indicators 51d and 51f (referred herein to as an air-conditioning indicator extinction command), whereby the air-conditioning indicator set is made extinct. Then, the indicator controller 54a goes to an end of the processing shown in FIG. 15.

At the step S142, the indicator controller 54a operates to determine whether or not the charge port 11 is put in a condition ready for a charge service, on the basis of information on a condition of use of the charge port 11 that the vehicle controller 70 has received from the detection element detecting a condition of use of the charge port 11. More specifically, the indicator controller 54a is adapted to determine whether or not a charge plug 210 is connected to the charge port 11, to thereby determine whether or not the charge port 11 is put in a condition ready for a charge service. If the charge port 11 is put in a condition ready for a charge service, the indicator controller 54a sets or holds on a timer on-off flag for a software timer (that is adapted to time an elapsed time while the timer is on), and goes to a step S143. Unless the charge port 11 is put in a condition ready for a charge service (that is, if the charge port 11 has no charge plug 210 connected thereto), the indicator controller 54a simply goes to the step S148.

At the step S143, the indicator controller 54a determines whether or not a prescribed interval of time has not yet been elapsed after a condition established to be ready for a charge service has been first determined at the step S142 (that is, whether or not an elapsed time on the software timer is shorter than the prescribed time). The indicator controller 54a goes to a step S144, when having determined that the prescribed time has not yet been elapsed after a condition ready for a charge service has been first determined (that is, if the elapsed time on the software timer is shorter than the prescribed time). The indicator controller 54a goes to a step S146, when having determined that the prescribed time has been elapsed after a condition ready for a charge service has been first determined (that is, if the elapsed time on the software timer is equal to or longer than the prescribed time).

At the step S144, the indicator controller 54a determines whether or not a reservation is left set up for a certain preliminary air-conditioning service. The indicator controller 54a goes to a step S145, when having determined that a reservation is left set up for a charge service. The indicator controller 54a goes to the step S148, when having determined that no reservation is left set up for any charge service.

At the step S145, the indicator controller 54a outputs “an indicator control command for blinking the set of air-conditioning indicators 51d and 51f” (referred herein to as an air-conditioning indicator blink command), whereby the air-conditioning indicator set is caused to blink. Then, the indicator controller 54a goes to an end of the processing shown in FIG. 15.

At the step S146, the indicator controller 54a determines whether or not a preliminary air-conditioning service is being executed. The indicator controller 54a goes to a step S147, when having determined that a preliminary air-conditioning service is being executed. The indicator controller 54a goes to the step S148, when having determined that no preliminary air-conditioning service is being executed, that is, when no preliminary air-conditioning service is executed at the charge port 11 to which a charge plug 210 has already been connected. When going from the step S146 to the step S148, the indicator controller 54a turns the timer on-off flag off, whereby the software timer is reset to the state of a count zero.

At the step S147, the indicator controller 54a outputs “an indicator control command for having the set of air-conditioning indicators 51d and 51f lighting, more specifically, continuously lighting” (referred herein to as an air-conditioning indicator continuous lighting command), whereby the air-conditioning indicator set is kept lit. Then, the indicator controller 54a goes to an end of the processing shown in FIG. 15. Those processing items shown in FIG. 15 are implemented as described.

There have been described fragmentary configurations of embodiments concerning FIG. 14 or FIG. 15. Those embodiments have remaining fragmentary configurations similar to corresponding fragmentary configurations of embodiments concerning any one of FIG. 1 through FIG. 13.

### Actions and Effects

Description is now made of a series of actions and effects at the vehicle system 1 according to embodiments concerning FIG. 14 or FIG. 15.

According to embodiments concerning FIG. 14 or FIG. 15, at the vehicle system 1, the indicator set 51 has, as individual subsets thereof, the set of charge indicators 51c and 51e and the set of air-conditioning indicators 51d and 51f put under a lighting control for one of the following patterns of actions.

As for the set of charge indicators 51c and 51e at the vehicle system 1, when the ignition is in the on state, the charge indicator set is rendered extinct (at the step S121 and the step S128).

At the vehicle system 1 with the ignition in the off state, if any reservation for a charge service is in a setup state, the set of charge indicators 51c and 51e keeps blinking within a prescribed time after a connection of the charge plug 210 to the charge port 11 (at processing items including the step S121 through the step S125).

At the vehicle system 1 with the ignition in the off state, if no reservation is left set up for a charge service, the set of charge indicators 51c and 51e is continuously lit even within the prescribed time after the connection of the charge plug 210 to the charge port 11 (at processing items including the step S121 through the step S124, and the step S127).

At the vehicle system 1 with the ignition in the off state, even when the prescribed time has elapsed since the connection of the charge plug 210 to the charge port 11, the set of charge indicators 51c and 51e is continuously lit, if any charge service is being executed (at processing items including the step S121 through the step S123, and processing items including the step S126 and the step S127).

At the vehicle system 1 with the ignition in the off state, when the prescribed time has elapsed since the connection of the charge plug 210 to the charge port 11, if no charge service is being executed (for instance, if a charge service executer 71 shown in FIG. 7 is in a waiting state), the set of charge indicators 51c and 51e is rendered extinct (at processing items including the step S121 through the step S123, and processing items including the step S126 and the step S128).

As for the set of air-conditioning indicators 51d and 51f at the vehicle system 1, when the ignition is in the on state, the air-conditioning indicator set is rendered extinct (at the step S141 and the step S148).

At the vehicle system 1 with the ignition in the off state, if any reservation for a preliminary air-conditioning service is in a setup state, the set of air-conditioning indicators 51d and 51f keeps blinking within the prescribed time after the connection of the charge plug 210 to the charge port 11 (at processing items including the step S141 through the step S145).

On the other hand, at the vehicle system 1 with the ignition in the off state, even when the prescribed time has elapsed since the connection of the charge plug 210 to the charge port 11, the set of air-conditioning indicators 51d and 51f is continuously lit, if any preliminary air-conditioning service is being executed (at processing items including the step S141 through the step S143, and processing items including the step S146 and the step S147).

At the vehicle system 1 with the ignition in the off state, when the prescribed time has elapsed since the connection of the charge plug 210 to the charge port 11, if no preliminary air-conditioning service is being executed (for instance, if a preliminary air-conditioning service executer 72 shown in FIG. 7 is in a waiting state), the set of air-conditioning indicators 51d and 51f is rendered extinct (at processing items including the step S141 through the step S143, and processing items including the step S146 and the step S148).

At the vehicle system 1 with the ignition in the off state, if no reservation is left set up for a preliminary air-conditioning service, the set of air-conditioning indicators 51d and 51f is rendered extinct even within the prescribed time after the connection of the charge plug 210 to the charge port 11 (at processing items including the step S141 through the step S144, and the step S148).

According to embodiments concerning any one of FIG. 1 through FIG. 15, the vehicle system 1 has a charge service reservation setter as well as an air-conditioning service reservation setter including e.g. the information input interface set 52 and the meter controller 54. The vehicle system 1 has a lighting element set including e.g. the indicator set 51. The vehicle system 1 has a controller including e.g. the indicator controller 54a. At the vehicle system 1, the lighting element set is operable to put a lighting element subset thereof in a first lighting state involving a subset (e.g., 51a, 51b, {51c, 51e}, or {51d, 51f}) of the indicator set 51 blinking, to represent a specific subset of the vehicle condition set described. At the vehicle system 1, the lighting element set is operable to put the lighting element subset in a second lighting state involving the subset of the indicator set 51 continuously lighting, to represent another specific subset of the vehicle condition set described.

### Modifications of Embodiments

According to embodiments described, the vehicle system 1 has employed a wired system using an intervening charge plug 210 for receiving electric power from an external power supply. However, embodiments described are not limited thereto. For instance, embodiments described may have a wireless system for receiving electric power supplied from an external power supply, without using any intervening charge plug 210. In this case, the indicator controller 54a may be adapted to determine that the charger 12 is put in a condition ready for execution of a charge service, when the condition affords to receive electric power supplied by the wireless system.

According to embodiments described, the indictor controller 54a is adapted to control a subset of the indicator set 51 to blink in preset periods for a prescribed interval of time, if any reservation is set up for a charge service or for a preliminary air-conditioning service, while the charge port 11 is put in a condition ready for execution of charge service. However, embodiments described are not limited thereto. For instance, if any reservation is set up for a charge service or for a preliminary air-conditioning service, under a condition of the charge port 11 ready for execution of charge service, embodiments described may have a subset of the indicator set 51 controlled for a continuous lighting or to blink in preset periods, also in the way up to the time to start the charge service or the preliminary air-conditioning service, as it is set up for the reservation.

According to embodiments described, during execution of a charge service at the vehicle system 1, the indicator set 51 may have a subset thereof blinked in a shorter period, as the high-voltage battery set 15 has a shorter remaining time left for the charge service.

According to embodiments described, at the vehicle system 1, the indicator set 51 has a subset thereof rendered extinct, under conditions of the charge port 11 immature for execution of charge service, even if a reservation is set up for a charge service or for a preliminary air-conditioning service. However, embodiments described are not limited thereto. For instance, at the vehicle system 1 with the charge port 11 being immature for execution of charge service, in spite of a reservation set up for a charge service or for a preliminary air-conditioning service, the indicator set 51 may have a subset thereof put in a specific lighting condition to inform a user of that vehicle condition. For instance, at the vehicle system 1, the indicator set 51 may have a subset thereof blinking or lighting in an adequate color (e.g. a red color) other than those used to represent vehicle conditions else. In this case, at the vehicle system 1, the indicator set 51 may have a subset thereof blinking or lighting for a preset interval of time.

According to a first aspect of embodiments of the invention described, there is provided a vehicle condition informing system adapted to inform a vehicle condition set of a vehicle 1 including a battery set 15 mounted on the vehicle 1 and adapted to charge from an external power supply 200 (with 210), and an air conditioner 30 operable for air conditioning services to be rendered when the external power supply 200 (with 210) is put in a state affording to supply electric power to the battery set 15, the vehicle condition informing system comprising a charge service reservation setter 54 (with 52) configured for a setup to be made of a reservation for execution of a charge service to the battery set 15, an air-conditioning service reservation setter 54 (with 52) configured for a setup to be made of a reservation for execution of an air-conditioning service, a charge service executer 71 configured to start charging the battery set 15 at a charge service starting clock time set up by the charge service reservation setter 54 (with 52), an air-conditioning service executer 72 configured to execute the air-conditioning service at an air-conditioning service starting clock time set up by the air-conditioning service reservation setter 54 (with 52), a lighting element set 51 comprising a first lighting element subset 51a (or 51c, 51d) or 51b (or 51e, 51f) thereof disposed at an interior of or at an outside of the vehicle 1, and a controller 54a configured to control an action set (FIG. 13) of the lighting element set 51, the controller being adapted to put the lighting element set 51 in a first lighting state S105, S125, or S145 representing a first subset of the vehicle condition set including a combination of a condition of the charge service reservation setter 54 (with 52) having set the charge service starting clock time or a condition of the air-conditioning service reservation setter 54 (with 52) having set the air-conditioning service starting clock time, and a condition of the external power supply 200 (with 210) put in the state affording to supply electric power to the battery set 15, and in a second lighting state S107, S127, or 147 representing a second subset of the vehicle condition set including the charge service to the battery set 15 or the air-conditioning service being executed, the second lighting state S107, S127, or 147 being different from the first lighting state S105, S125, or S145.

According to a second aspect of embodiments of the invention described, there is provided the vehicle condition informing system according to the first aspect of embodiments of the invention, wherein the lighting element set 51 has the first lighting element subset 51a (or 51c, 51d) or 51b (or 51e, 51f) disposed at one 60 or 11 of a first location at a dashboard 60 at the interior of the vehicle 1 and a second location at a plug receptacle 11 provided at the outside of the vehicle 1 for a plug 210 to be applied to supply electric power from the external power supply 200.

According to a third aspect of embodiments of the invention described, there is provided the vehicle condition informing system according to the second aspect of embodiments of the invention, wherein the lighting element set 51 comprises a second lighting element subset 51b (or 51e, 51f) or 51a (or 51c, 51d) thereof disposed at the other 11 or 60 of the first location 60 and the second location 11.

According to a fourth aspect of embodiments of the invention described, there is provided the vehicle condition informing system according to the first aspect of embodiments of the invention, wherein the controller 54a is configured to have the lighting element set 51 blinking in a preset period for the first lighting state S105, S125, or S145, and have the lighting element set 51 continuously lighting for the second lighting state S107, S127, or S147.

According to a fifth aspect of embodiments of the invention described, there is provided the vehicle condition informing system according to the first aspect of embodiments of the invention, wherein the controller 54a is configured for operations to have the lighting element set 51 blinking in a preset period for the first lighting state S105, S125, or S145, and for a combination of operations in execution of the air-conditioning service to have the lighting element set continuously lighting and operations in execution of the charge service for the battery 15 set to have the lighting element set 51 blinking in a shorter period, as the battery set 15 has a shorter remaining time left for the charge service, for the second lighting state S107, S127, or S147.

According to a sixth aspect of embodiments of the invention described, there is provided the vehicle condition informing system according to the first aspect of embodiments of the invention, wherein the lighting element set 51 comprises a charge informing lighting element subset {5c, 5e} controllable to the first lighting state S125 or the second lighting state S127 with respect to the charge service for the battery set 15, and an air-conditioning informing lighting element subset {5d, 5f} controllable to the first lighting state S145 or the second lighting state S147 with respect to the air-conditioning service.

According to a seventh aspect of embodiments of the invention described, there is provided the vehicle condition informing system according to the first aspect of embodiments of the invention, wherein the controller 54a is configured to have the lighting element set 51 put in a third lighting state S109, S128, or S148 different from the first lighting state S105, S125, or S145 and the second lighting state S107, S127, or S147, under a combination of the condition of the charge service reservation setter 54 (with 52) having set the charge service starting clock time or the condition of the air-conditioning service reservation setter 54 (with 52) having set the air-conditioning service starting clock time, and a condition immature for the external power supply 200 (with 210) to supply the battery set 15 with electric power.

It is noted that embodiments of the invention described have a set of aspects including the fourth aspect and the second or the third aspect of embodiments of the invention, a set of aspects including the fifth aspect and the second, the third, or the fourth aspect of embodiments of the invention, a set of aspects including the sixth aspect and the second, the third, the fourth, or the fifth aspect of embodiments of the invention, and a set of aspects including the seventh aspect and the second, the third, the fourth, the fifth, or the sixth aspect of embodiments of the invention.

According to the first aspect of embodiments of the invention, there is a vehicle condition informing system adapted to accept a reservation for a charge service to the battery set 15 or for an air-conditioning service, and start the charge service to the battery set or the air-conditioning service at a reserved clock time.

According to the first aspect of embodiments of the invention, the vehicle condition informing system permits the lighting element set 51 to have different lighting states between a stage of having a reservation set up for a charge service to the battery set 15 or for an air-conditioning service, and a stage of executing the charge service to the battery set 15 or the air-conditioning service, thus affording for the user to know the more specific vehicle condition.

According to the first aspect of embodiments of the invention, at the vehicle condition informing system, the lighting element set 51 is put in a lighting state when the external power supply 200 has got to a condition ready for supply of electric power to the battery set 15, if any setup is established for reservation of a charge service to the battery set 15 or for reservation of an air-conditioning service. The lighting element set 51 in the lighting state is effective to keep the user from having forgotten putting the external power supply 200 in a condition to be ready for power supply to the battery set 15, after establishment of the setup for reservation of the charge service to the battery set 15 or for reservation of the air-conditioning service. Therefore, according to the first aspect of embodiments of the invention, the vehicle condition informing system can serve to prevent development of a situation involving a failure to execute a charge service or air-conditioning service at a clock time reserved to start execution.

According to the second or third aspect of embodiments of the invention, there is a vehicle condition informing system affording for a user to know vehicle conditions with ease by provision of a subset of the lighting element set 51 in a place easy for visual access by the user.

According to the fourth aspect of embodiments of the invention, there is a vehicle condition informing system affording for a user to check a lighting state of the lighting element set 51, to know presence or absence of a setup made for reservation of a charge service to the battery set 15 or for reservation of an air-conditioning service, as well as whether or not the charge service to the battery set 15 or the air-conditioning service is being executed.

According to the fifth aspect of embodiments of the invention, there is a vehicle condition informing system affording for a user to check a lighting state of the lighting element set 51, to know a remaining charge time left for the battery 15.

According to the sixth aspect of embodiments of the invention, there is a vehicle condition informing system affording for a user to be individually informed of a combination of reservation condition and execution condition of a charge service to the battery set 15, and a combination of reservation condition and execution condition of an air-conditioning service.

According to the seventh aspect of embodiments of the invention, there is a vehicle condition informing system including the lighting element set 11 adapted to get to the third lighting state S109, S128, or S148 under a condition immature for the external power supply 200 to supply the battery set 15 with electric power, in combination with a setup made for reservation of a charge service to the battery set 15 or for reservation of an air-conditioning service, which lighting state S109, S128, or S148 is effective to prevent the user from having forgotten putting the external power supply 200 in a condition to be ready for power supply to the battery set 15, when having established a setup for reservation of the charge service to the battery set 15 or for reservation of the air-conditioning service.

Although embodiments of the invention have been described, those embodiments are illustrative, and should not be construed restrictive. Artisan may perceive modifications of described embodiments with ease, within the scope defined by appended claims.

### REFERENCE SIGNS LIST

1 vehicle system
10 drive system
15 high-voltage battery set
30 air-conditioning system
50 meter & indicator control system
51 indicator set
51a indicator
51b indicator
51c indicator element
51d indicator element
51e indicator element
51f indicator element
52 information input interface set
54 meter controller
54a indicator controller
70 vehicle controller
71 charge service executer
72 preliminary air-conditioning service executer

What is claimed is:

1. A vehicle condition informing system adapted to inform a vehicle condition set of a vehicle including
a battery set mounted on the vehicle and adapted to charge from an external power supply, and
an air conditioner operable for air conditioning services to be rendered when the external power supply is put in a state affording to supply electric power to the battery set,
the vehicle condition informing system comprising:
a charge service reservation setter configured for a setup to be made of a reservation for execution of a charge service to the battery set;
an air-conditioning service reservation setter configured for a setup to be made of a reservation for execution of an air-conditioning service;
a charge service executer configured to start charging the battery set at a charge service starting clock time set up by the charge service reservation setter;
an air-conditioning service executer configured to execute the air-conditioning service at an air-conditioning service starting clock time set up by the air-conditioning service reservation setter;
a lighting element set comprising a first lighting element subset thereof disposed at an interior of or at an outside of the vehicle; and
a controller configured to control an action set of the lighting element set, the controller being adapted to put the lighting element set
in a first lighting state representing a first subset of the vehicle condition set including a combination of a condition of the charge service reservation setter having set the charge service starting clock time or a condition of the air-conditioning service reservation setter having set the air-conditioning service starting clock time, and a condition of the external power supply put in the state affording to supply electric power to the battery set, and
in a second lighting state representing a second subset of the vehicle condition set including the charge service to the battery set or the air-conditioning service being executed, the second lighting state being different from the first lighting state.

2. The vehicle condition informing system according to claim 1, wherein the lighting element set has the first lighting element subset disposed at one of a first location at a dashboard at the interior of the vehicle and a second location at a plug receptacle provided at the outside of the vehicle for a plug to be applied to supply electric power from the external power supply.

3. The vehicle condition informing system according to claim 2, wherein the lighting element set comprises a second lighting element subset thereof disposed at the other of the first location and the second location.

4. The vehicle condition informing system according to claim 1, wherein the controller is configured to have the lighting element set blinking in a preset period for the first lighting state, and have the lighting element set continuously lighting for the second lighting state.

5. The vehicle condition informing system according to claim 1, wherein the controller is configured for operations to have the lighting element set blinking in a preset period for the first lighting state, and for a combination of operations in execution of the air-conditioning service to have the lighting element set continuously lighting and operations in execution of the charge service for the battery set to have the lighting element set blinking in a shorter period, as the battery set has a shorter remaining time left for the charge service, for the second lighting state.

6. The vehicle condition informing system according to claim 1, wherein the lighting element set comprises a charge informing lighting element subset controllable to the first lighting state or the second lighting state with respect to the charge service for the battery set, and an air-conditioning informing lighting element subset controllable to the first lighting state or the second lighting state with respect to the air-conditioning service.

7. The vehicle condition informing system according to claim 1, wherein the controller is configured to have the lighting element set put in a third lighting state different from the first lighting state and the second lighting state, under a combination of the condition of the charge service reservation setter having set the charge service starting clock time or the condition of the air-conditioning service reservation setter having set the air-conditioning service starting clock time, and a condition immature for the external power supply to supply the battery set with electric power.
